(19) United States
(12) Patent Application Publication
(10) Pub. No.: US 2007/0058370 A1
(43) Pub. Date: Mar. 15, 2007

(54) Backlight module and display utilizing same

(75) Inventors: Chang-Ho Shen, Hsinchu City (TW); Hui-Kai Chou, Taipei City (TW); Chih-Kang Tung, Houlong Township (TW); Wen-Hsin Lin, Jhunan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Au Optronics Corp.

(21) Appl. No.: 11/358,233

(22) Filed: Feb. 21, 2006

(30) Foreign Application Priority Data
Sep. 12, 2005 (TW) 94131289

(51) Int. Cl. F21V 23/02

(52) U.S. Cl. 362/260

(57) ABSTRACT

A backlight module includes a substrate and at least a lamp. The substrate includes a high-voltage side, a low-voltage side and a bottom surface linking therebetween. The lamp includes two electrode ends respectively connecting to the high-voltage side and the low-voltage side. The lamp and the bottom surface form an acute angle to reduce leakage current percentage. A display includes the backlight module.

### BACKGROUND

The invention relates to a backlight module and a display utilizing same.

Referring to FIG. 1, conventional backlight module 10 comprises a base 11 and a lamp 12. The base 11 comprises a bottom surface 111. The lamp 12 comprises two electrode ends 121 and 122, a high voltage 112 and a low voltage 113. The electrode ends 121 and 122 are configured to receive the high voltage 112 and the low voltage 113. The electrode ends 121 and 122 are respectively and electrically connected to the high-voltage 112 and the low-voltage 113. The lamp 12 installed in the base 11 parallel to the bottom surface 111 may generate floating capacitance. The floating capacitance results in current leakage. Referring to FIG. 2, a line T₀ shows current leakage percentage variation of the lamp 12 from the high-voltage 112 to the low-voltage side. A distance between the high-voltage 112 and the low-voltage 113 is L. The current leakage percentage % of the lamp 12 increases gradually from the high-voltage side 112 to low-voltage 113, thus, the illumination near the low-voltage 113 is less than that near the high-voltage 112. Conventional backlight modules are not capable of providing average illumination. Moreover, current leakage of the backlight module wastes power.

### SUMMARY

The invention provides a backlight module and a display utilizing same. The backlight module includes a base and at least a lamp. The base has a bottom surface. The lamp includes a first electrode and a second electrode. The first electrode is configured to receive a high voltage. The second electrode is configured to receive a low voltage. The distance between the first electrode and the bottom surface is shorter than that between the second electrode and the bottom surface. A display comprises the backlight module.

The backlight module may further comprise a plurality of fixing elements installed on the base for securing the lamp to the backlight module.

Furthermore, the lamp may be a cold cathode fluorescent lamp.

### BRIEF DESCRIPTION OF THE DRAWINGS

The invention can be more fully understood by reading the subsequent detailed description in conjunction with the examples and references made to the accompanying drawings, wherein:

FIG. 1 is a schematic drawing of a conventional backlight module;

FIG. 2 shows the variation of the current leakage percentage of a lamp in a conventional backlight module;

FIG. 3 is a schematic drawing of a backlight module of the invention; and

FIG. 4 is a graph showing the variation of current leakage percentage of T₀ and T₁.

### DETAILED DESCRIPTION

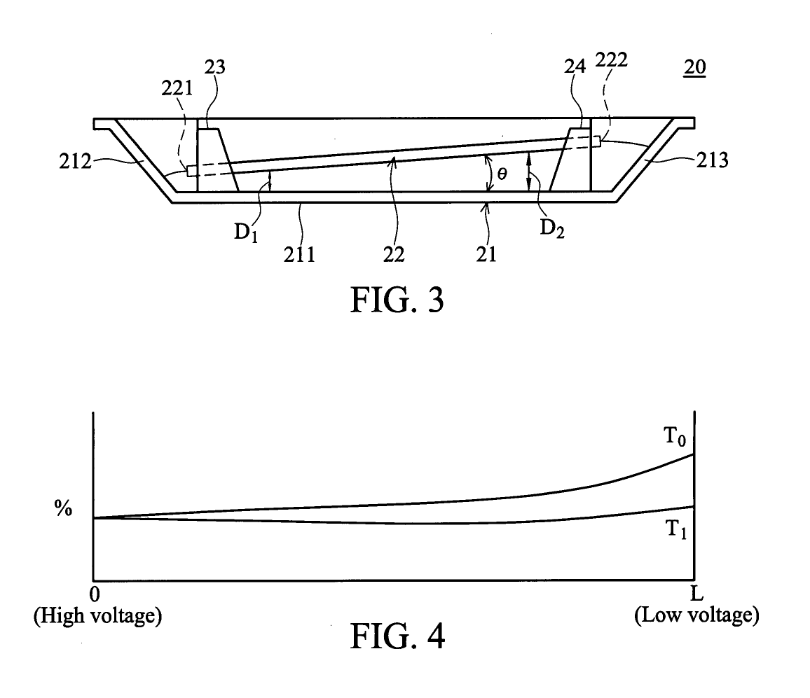

Referring to FIG. 3, a backlight module 20 comprises a base 21, lamp 22 and fixing elements 23 and 24. The fixing elements 23 and 24 are installed on two sides of the base 21 to secure the lamp 22. The base 21 comprises a bottom surface 211, a high-voltage side 212 and a low-voltage side 213. The bottom surface 211 is located between the high-voltage side 212 and low-voltage side 213. The lamp 22 comprises a first electrode 221 and a second electrode 222. The first electrode 221 is configured to receive a high voltage. The second electrode 222 is configured to receive a low voltage. The distance D₁ between the first electrode 221 and the bottom surface 211 is shorter than the distance D₂ between the second electrode 222 and the bottom surface 211. An acute angle θ is formed between the lamp 22 and the bottom surface 211. In this embodiment, the lamp 22 is a cold cathode fluorescent lamp.

Referring to FIGS. 3 and 4, the current leakage formula is %=ζ*A/d, wherein % represents the percentage of current leakage in a lamp, ζ is dielectric coefficient, A is projection area of a lamp, d is a distance between a lamp and a bottom surface. In a backlight module, the projection area A of the lamp 22 on the bottom surface 211 is constant. When the dielectric coefficient ζ decreases, the current leakage percentage % of a lamp decreases. Furthermore, when the distance d between the lamp 22 and bottom surface 211 increases, the current leakage percentage % of a lamp decreases. In the invention, the distance d between the lamp 22 and the bottom surface 211 is varied to reduce the current leakage percentage % which gradually increases from the high-voltage side 212 to the low-voltage side 113. In the invention, therefore, the distance D₂ is greater than the distance D₁. The distance d between the lamp 22 and the bottom surface 211 is gradually increased from the high-voltage side 212 to the low-voltage side 213, thus, the current leakage % near the low-voltage side 213 of the lamp 22 is decreased.

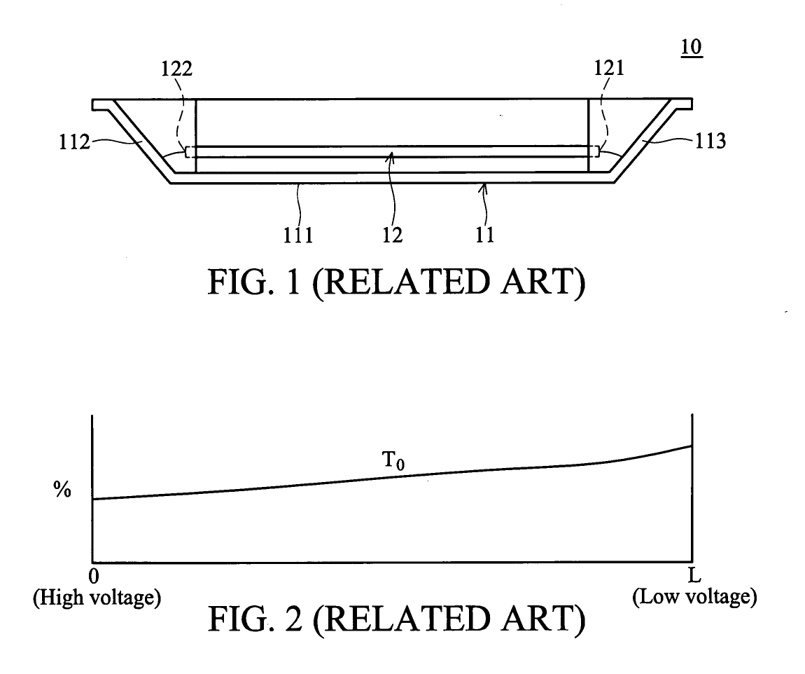

Referring to FIG. 4, line T₀ shows current leakage percentage variation of the lamp 12 (shown in FIG. 1) from high-voltage side 112 to low-voltage side 113. Line T₁ shows current leakage percentage variation of the lamp 22 (shown in FIG. 3) from high-voltage side 212 to low-voltage side 213. A comparison of line T₀ with line T₁ shows that the current leakage percentage of the lamp 12 increases from the high-voltage side 112 to the low-voltage side 113. In the invention, therefore, the distance between the lamp 22 and the bottom surface 211 is gradually increased from the high-voltage side 212 to the low-voltage side 213, thereby significantly reducing the total amount of the current leakage. Moreover, the illumination of the lamp 22 is more uniform and the power used is less.

The backlight module 20 of the invention is applied to a display (not shown) for example, a liquid crystal display. The backlight module 20 provides a display which can provide average illumination and save power.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a base having a bottom surface; and
at least one lamp having a first electrode configured to receive a high voltage, and a second electrode configured to receive a low voltage;
wherein the distance between the first electrode and the bottom surface is shorter than that between the second electrode and the bottom surface.

2. The backlight module as claimed in claim 1, further comprising a plurality of fixing elements installed on the base for fixing the lamp.

3. The backlight module as claimed in claim 1, wherein the lamp comprises a cold cathode fluorescent lamp.

4. A display, comprising a backlight module as claimed in claim 1.
